(19) United States
(12) Patent Application Publication
(10) Pub. No.: US 2015/0228160 A1
(43) Pub. Date: Aug. 13, 2015

(54) Complementary Bets In Games Of Chance

(71) Applicant: Bet Trade Limited, London (GB)

(72) Inventors: George Georgiopoulos, Greater London (GB); Giannis Galanis, Greater London (GB)

(21) Appl. No.: 14/425,541

(22) PCT Filed: Sep. 4, 2013
(86) PCT No.: PCT/GB2013/052313

§ 371 Date: Mar. 3, 2015

(30) Foreign Application Priority Data
Sep. 4, 2012 (GB) 1215708.7

(51) Int. Cl. G07F 17/32

(52) U.S. Cl. CPC G07F 17/3288; G07F 17/3244

(57) ABSTRACT

A computer or computer system for operating a game of chance, the computer or computer system comprising at least one processor, means for receiving a plurality of bets from players; and memory for storing the received bets, wherein the computer or computer system is operable under the control of at least one processor to offer bets of chance of any explicit odds, and guarantee the probability of winning, and to conduct a draw to determine one of more winning bets from said plurality of received bets stored in memory in accordance with said guaranteed probability of winning.

### FIELD OF THE INVENTION

This invention relates to games of chance, in particular computer systems conducting games of chance, for example over the Internet, in which multiple players can each wager a sum of money (or other wager) in order to have an opportunity to win a further sum of money (or other prize).

### BACKGROUND

Betting games fall into two main sectors; games of chance and betting on event outcomes. In games of chance the player wagers a sum of money on the result of a random event, simulated by a random number generator in computer systems. Such games include, among others, roulette, craps, blackjack, slots and lottery. When betting on event outcomes, also known as fixed-odd betting, the player wagers a sum of money on the result of an external event, commonly, but not limited to, a sport event.

When the random or external event resolves, the bet declares profit or loss. Hence, there is inherent requirement for a second party to be exposed to the other side of the transaction and cover the loss or claim the profit. Essentially, the second party wagers the same amount on the event not occurring. The second party is the House for games of chance and the Bookmaker for betting on events. They act as physical entities that host the game and cover all incoming bets.

Specifically for games of chance, different configurations of the House host low-odds and high-odds games. Low-odds, typically less than 50:1, refer to roulette, craps, blackjack, etc. This type of house has the ability to offer explicit odds, meaning a bet for which the player knows beforehand the odds he is engaged into, e.g. when betting on roulette black the odds are always 1:1. High-odds games include lottery, scratch-cards, slots etc. and offer odds up to and beyond 1,000,000:1. The player that engages in such a game is exposed to a large list of possible odds with every bet, e.g. every bet on slots can potentially offer, among others, odds of 2:1, 5:1, 80:1, 200:1, 10,000:1 etc. This significantly distorts the statistical balance between odds and probability of winning, e.g. in a typical slots game the probability of receiving odds 5:1 is only 1 in 33.

The House covers all bets independently, therefore must typically retain a large cash reserve to cover all possible prize payouts. Additionally, its unsophisticated structure introduces several limitations that severely handicap the gaming experience of the players, them being
1) Under any technical configuration it is not possible to offer high-odds, .i.e. higher than 50:1, in an explicit manner.
2) Odds never statistically reflect the probability of winning, either due to the House edge and/or the diluted probability among several simultaneous winning odds, which occurs in high-odds bets. Probability of winning is very important, since only games of chance can guarantee it, as opposed to fixed-odds betting.

The structure of the House as a physical entity can only cover a plurality of bets by covering each one independently. The same holds for the Bookmaker in fixed-odd betting. However, fixed-odd betting has been presented with an alternative solution that creates additional betting liquidity with the help of a betting exchange. The exchange allows players to bet against each other on the same event; hence betting is not limited by the cash reserve of the bookmaker. This is achieved by allowing players to bet on events not occurring, also known as lay betting an event, in which case all bets are covered by the respective lays in the exchange.

However, this approach is not operational in games of chance, because laying bets is faced with various technical and practical difficulties. For instance, laying a bet of chance implies betting on all remaining outcomes simultaneously. In a typical roulette game for example, laying a bet on pocket #1 translates into betting on all remaining pockets, which is both impractical, and conflicts with the point of the game from a player's perspective. In high-odds games where the possible outcomes are millions, the option of constructing a separate lay for each bet is practically impossible.

For games of chance, no technology has presented a solution to offer lay bets, or otherwise an alternative working solution that can natively increase betting liquidity without offering lay bets. For this reason the House is the only physical or electronic entity to currently host games of chance.

### SUMMARY OF INVENTION

Embodiments of the present invention provide an electronic entity/computer system that can replace the physical implementation of the House, offer bets of chance of any explicit odds, and guarantee the probability of winning. More specifically the invention provides the users/players access to
Bets of chance of any odds low or high (e.g. 1000000:1) in explicit manner
Bets of chance that reflect a fixed and given probability of winning
   Additionally, the invention makes possible to host bets of chance without the technical limitations of a cash reserve.

Embodiments of the present invention provide a computer or computer system that creates betting liquidity by way of complementary bets without the presence of lay bets. This effect allows users to place bets, via the Internet, in a computer or computer system that requires neither a House to bank the bets nor lay bets placed from other users.

For this purpose, the computer or computer system initially defines all the wagers as two data points; the amount a player wants to bet, and the amount he wants to win. Bets defined in such way don't reflect or natively include commission of any form; betting $1 to win $36, will instantly suggest that the odds of this bet are 35:1, and the probability to win is exactly 1 in 36. Also, this suggests that the expected value, or fair price, of the bet is exactly $1. This example would be analogous to a roulette bet of $1 on any wheel number, given that we disregard the casino edge. This method allows the computer or computer systems to increase bet liquidity by defining all bets in the same way regardless of their odds.

The suggested computer system will receive a plurality of such bets by the players/users. It will simultaneously treat each bet as a potential capital cover for a bet of complementary odds, e.g. betting of $1 to win $36, is identical to covering a bet of $35 to win $36. Embodiments of this invention will construct more complex complementary bets from composite combinations of more than one bets. In this manner, several, even thousands, of bets can collectively construct a cover for another individual bet, regardless of the value of their data points.

Eventually the computer or computer system will create groups of bets whereby for every bet in the group, the remaining bets complete cumulatively its statistically equivalent complementary bet. In that way, that specific group of bets is self-sufficient, i.e. it can esoterically satisfy its own member bets. The proposed computer system will create a custom fair draw environment, to award the winning bets. The proposed computer or computer system will preserve the odds and probability of winning for all bets in the group.

The proposed technology uses the players' bets to inject betting liquidity back in the system for the benefit of other players. As a result the players can declare any bet they choose, with high or low odds, and the proposed computer system can guarantee such a bet in an explicit manner. Additionally, the computer system can operate without the technical limitation of keeping a cash reserve, hence bets are offered without the presence of a House edge.

Within the environment created by the computer or computer system, whereby the probabilities of winning are known, there is no House and all bets are covered by other bets, embodiments of the invention will also give players the chance to exchange their bets at a price they choose. The computer or computer system will allow players to exchange bets of various odds at any price they like and inject further liquidity for the benefit of faster bet execution.

### BRIEF DESCRIPTION OF FIGURES

FIG. 1 shows the system components;

FIG. 2 shows a generic presentation of a bet $x to win $y represented as a block;

FIG. 3 shows specific examples of bets represented as blocks;

FIG. 4 shows an example of individual bet blocks being combined into a compound block;

FIG. 5 shows examples of compound blocks for matched bets;

FIG. 6 shows an example of an annular compound block with annulus segment bet blocks;

FIG. 7 shows examples of sliced compound blocks;

FIG. 8 shows examples of sliced compound blocks after draws have been completed;

FIG. 9 shows a compound blocks as used in the proof that the approach exemplified below results in a fair draw;

FIG. 10 shows an illustration of the exchange user interface;

FIGS. 11-13 show representations of the user interface.

### DETAILED DESCRIPTION

The invention provides a computer program comprising program code that when executed on a computer or computer system causes the computer or computer system to offer bets of chance of any explicit odds, guarantee the probability of winning, and negate the technical limitations of a cash reserve requirement, i.e. replace the physical implementation of the House.

Methods in accordance with the above are preferably computer-implemented methods, with the method steps being carried out by one or more computer processors in a computer or computer system configured to receive bets from one or more players and to notify players of winning and/or losing bets. In some embodiments, the computer system is accessible to players via the Internet.

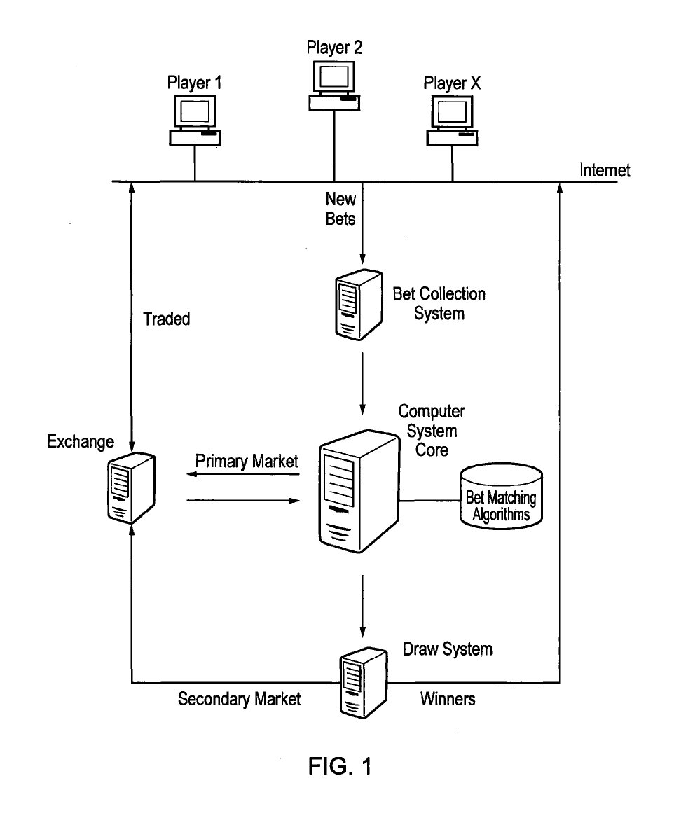

Embodiments of the present invention preferably provide a computer or computer system that builds complementary bets and interfaces with these discrete sub-systems; Bet Placement, Draw, and Bet Exchange (FIG. 1).

Embodiments of this invention preferably include a Bet Placement system, which via an electronic network accumulates electronic bet requests from users/players. This process feeds the computer or computer system, which matches these bets together. Bets that cannot be instantly matched will be redirected via an electronic network to the Bet Exchange, which will use them to create bet opportunities of instant execution.

Embodiments of this invention will preferably include a Draw system that will receive from the computer or computer system any groups of matched bets. This a implementation will construct a fair draw arrangement for this particular group of bets, which will include assigning unique multiple identifiers or ‘tokens’ for each bet. These identifiers will participate in a fair random selection, which will guarantee a fair draw environment to select winning bets. It must be noted that this process maintains that occasionally several tokens might be shared between bets, and/or bets might own several tokens. In any case, the process will be conducted in such a manner that all bet odds and probabilities of winning are preserved.

In preferred embodiments, the Draw Implementation will gradually eliminate identifiers/tokens in predetermined intervals following a fair random selection, which is defined as a Draw in Rounds. In this process, the winning identifier/token, and hence the winning bet, will be determined in a gradual manner. During this process the participating bets will appreciate or depreciate in value according to their success of their tokens, which will affect the statistical assessment of each bet.

In preferred embodiments, the player/user will have the opportunity to liquidate a bet which is in-between a Draw in Rounds. Based on the statistical value of the bet, or the current supply and demand, the user/player may place the bet via the network on the Bet Exchange with a preferred asking price. Alternatively, the player/user may instantly liquidate the bet by a live bid for an identical bet offered by another player/user.

### Bet Placement

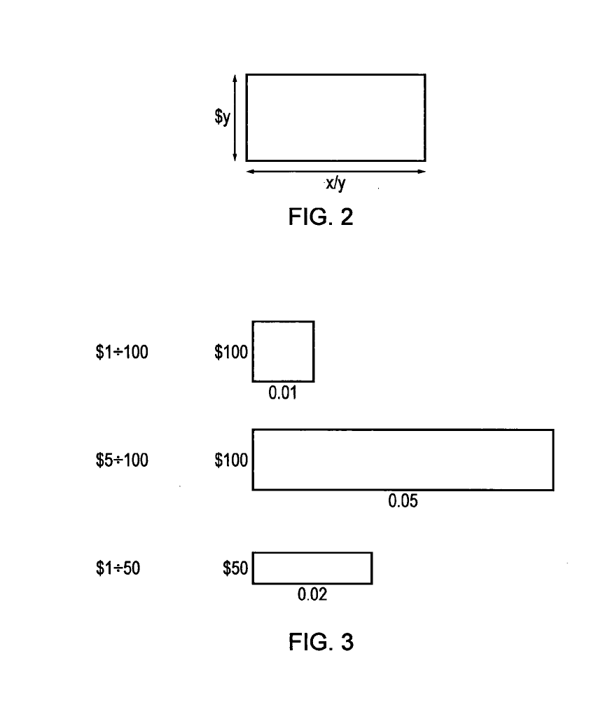

Embodiments of the invention include the configuration of a server that can accept bets from players, of client systems, over a communications framework, where each bet is defined by two data points (FIG. 2). The server will receive the data points and utilise its technical architecture, generally comprised of memory and processor to standardise them in accordance with the embodiments of the invention.

In preferred embodiments the two data points are the amount the player bets (x), and the amount the player intends to win (y). However, any alternative pair of data points can be utilised, as long as x and y can be explicitly calculated; a possible alternative pair being the amount to win, and the probability of winning, and others. Different combinations that involve odds, probability of winning, and expected value are also possible.

An example described as a combination of the amount the player bets, and the amount he expects to win is: bet $5 to win $100.

In preferred embodiments this is denoted as:

$5÷100

Meaning:
The player bets $5
The player may win (if successful) $100
The probability of winning $100 is 5/100=5%

In official betting terminology it means either of the following:
Bet $5 with decimal odds 20
Bet $5 with fractional odds 19:1

In the general case, betting $x÷y means:
The player bets $x
Cash at risk: $x
Expected value: $x
The player may win $y
Payout: $y
The probability of winning is x/y
The player bets $x with decimal odds y/x
The player bets $x with fractional odds (y/x−1):1

The following definition is conclusive:

$x÷y describes a bet,
where the players bets $x
with decimal odds=y/x,
and probability of winning=x/y

Having set out the bet definition and notation, we can consider an example of the method for conducting a game of chance in accordance with an embodiment of the invention. There are two main parts to the method: combining bets and making the draw, discussed in turn below.

### Computer System Core

Preferred embodiments of the invention provide a computer implementation that combines bets, the method comprising:
Receiving a plurality of bets
Converting bets into betting blocks, or other equivalent geometrical forms
Combining betting blocks in a solid compound betting block, or other equivalent form

This implementation presents with a visual representation on how the functionality of the Computer System is possible. Different representations, e.g. with annuli, or other geometrical or analytical translations, would illustrate the same effect.

Each bet is presented as “bet value x to attempt to win value y”.

The step of combining the plurality of bets comprises converting the two data-points of the bet, x and y, into a graphical representation as a shape having at least two dimensions and combining the shapes to form a two-dimensional bet space, wherein the bet space is made up of a mosaic of the shapes.

More specifically, the method comprises:
1) Converting each bet into a betting block defined by two dimensions, a first dimension proportional to data point y, and a second dimension representing a ratio of the data point x over data point y (should the shape form a rectangle, this means that the area of the betting block represents the size of the bet, x, which is equal to expected value);
2) Combining two or more betting blocks to form a compound betting block containing said two or more betting blocks, wherein the compound betting block is defined in the same way.

In preferred embodiments, once a compound block is formed with the method of perfect tiling, i.e. creating a perfect rectangle without gaps, then its dimensions would define its bet equivalent, i.e. its first dimension representing the new data point y, and its second dimension representing new data point x over new data point y.

Even though this method clearly displays the bet and win amounts, as well as the probabilities of winning and expected value, it doesn't show the price at which the player can buy this block. Price, P, adds a third dimension to the representation of the bet. Hence, this three-dimensional block will have y, x/y and P as its three dimensions. Should the third dimension (P) equal the size of the bet and expected value, x, the price is defined as ‘fair’. Should this not be the case, the bet will be over-valued or under-valued. Although fair bets for any odds will always be available by the Computer System, at the same time over-valued or under-valued bets may be quoted at the exchange based on supply and demand. The third dimension of price may be defined graphically, as suggested above, or separately as the cost of the two-dimension block. For simplicity, the embodiments of the present will generally refer to the bets as two-dimensional, excluding the third (P) dimension. However, this third dimension may be superimposed as needed.

This approach, representing each bet in two dimensions to form an area equal to the expected value of the bet, makes it possible to combine bets even where the bets to be combined do not share the same bet value and/or win value, so long as the betting blocks representing the bets to be combined are selected so that together they can be ‘tiled’, that is placed adjacent one another, to form a compound betting block that can itself be defined by the two dimensions. This infers that many bets will be combined together to increase the speed at which betting pools are created, improving player experience and bet liquidity.

Preferably, the two dimensions defining each betting block can be represented as a two dimensional shape of rectangular form. However, the bets can also be represented in the shape of an annulus through a simple transformation where the first dimensions are identical and the second dimension is transformed from a length of x/y to an angle of 360*(x/y). Hence, the compound betting blocks can be rectangular or segments of an annulus (including a complete annulus).

More generally, when all the bets have the same first dimension, any shape can be used as long as it has the same area as that defined for the rectangle, i.e. equal to the expected value of the bet. For example, a bet of $1 to win $100 can be represented as a rectangle of $100 by 0.01 (or y by x/y), but can also be a circle of radius equal to 1/\sqrt{π}, an equilateral triangle with sides equal to 2/\sqrt{\sqrt{3}}, and so on, all maintaining area equal to 1. Depending on the shapes chosen for the betting block and the way they are ‘tiled’, the shape of the resulting pool will also be defined. This can be designed to form a geometric shape or not. However, in preferred embodiments all pools will have an area equal to the prizes distributed to the players. This rule ensures that the probability of winning can be guaranteed and that the fairness of the game is preserved. For simplicity, the embodiments of the present invention will generally refer to pools that take the form of a rectangular or annular compound betting blocks, where the two dimensions defining the compound betting block are then represented by the same form of two-dimensional shape as each of the betting blocks that make up the compound betting block.

The approach to combining bets comprises converting or representing each bet as a two dimensional block (in this example a rectangle) and then combining the individual bet blocks into a compound block that can subsequently be used for the draw.

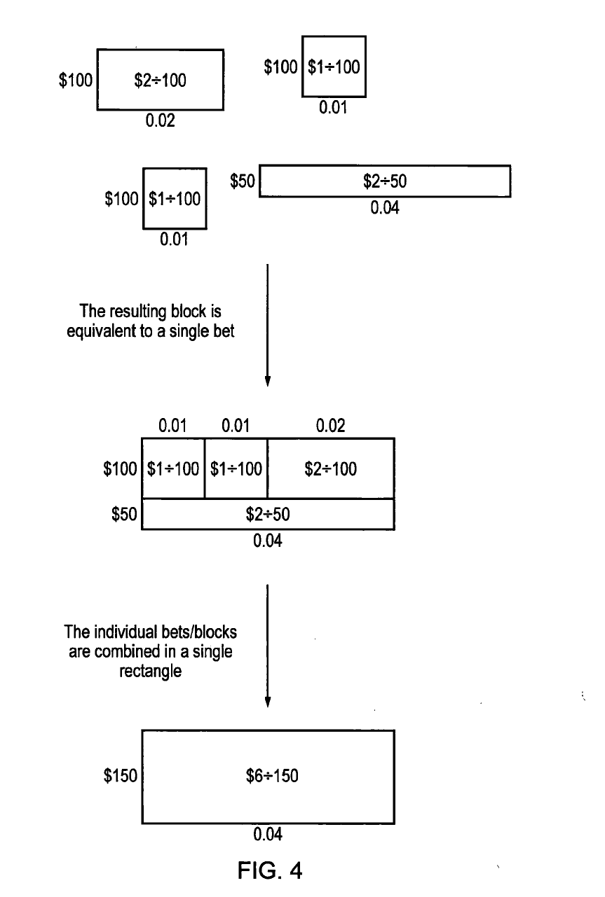

Assume a random bet $x-y (e.g. $1÷100), where the bet is represented as a rectangular block with a first dimension $y and a second dimension x/y, as seen in FIG. 2. Specific examples of blocks representing bets are shown in FIG. 3.

Betting blocks can be combined to form new larger betting blocks (“compound blocks”), so long as they form a complete rectangle with perfect tiling. The compound block is statistically equivalent to a new bet, whose characteristics are determined by its dimensions.

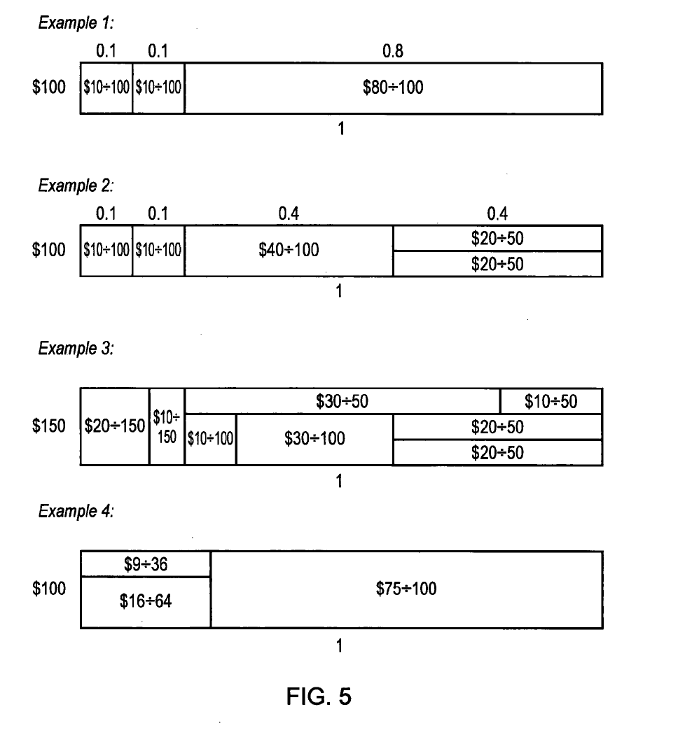

An example is shown in FIG. 4. In this example, two bets of $1÷100 are combined with a bet of $2÷100 and a bet of $2÷50, to form a compound block that has a first dimension of $150 (the total pay-out) and a second dimension of 0.04, which suggests a bet equivalent equal to $6÷150.

In this representation, when combining blocks to form a compound block, the constituent blocks must preserve orientation, i.e. the height always represents win amount y, and length represents x/y.

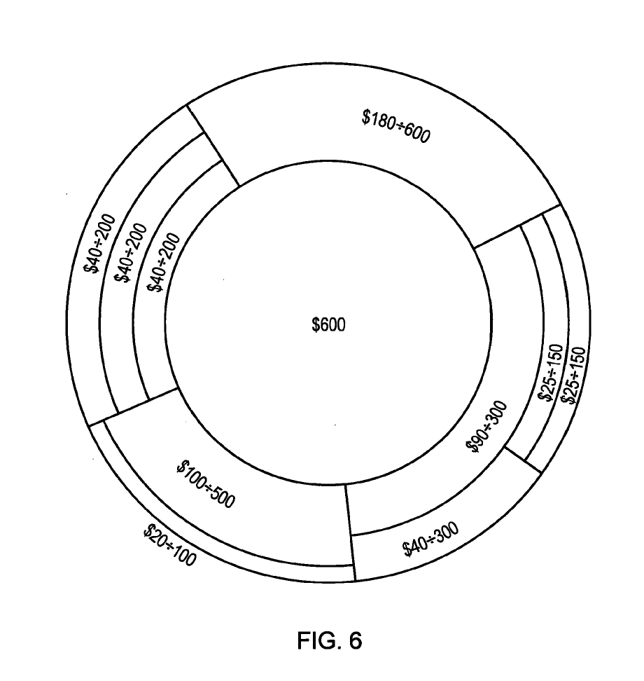

A set of bets is defined as successfully matched and in a state where a fair draw is possible when the set of bets can compose a compound block with horizontal (second) dimension equal to 1. The vertical dimension can take any amount of currency. Examples of matched blocks are shown in FIG. 5.

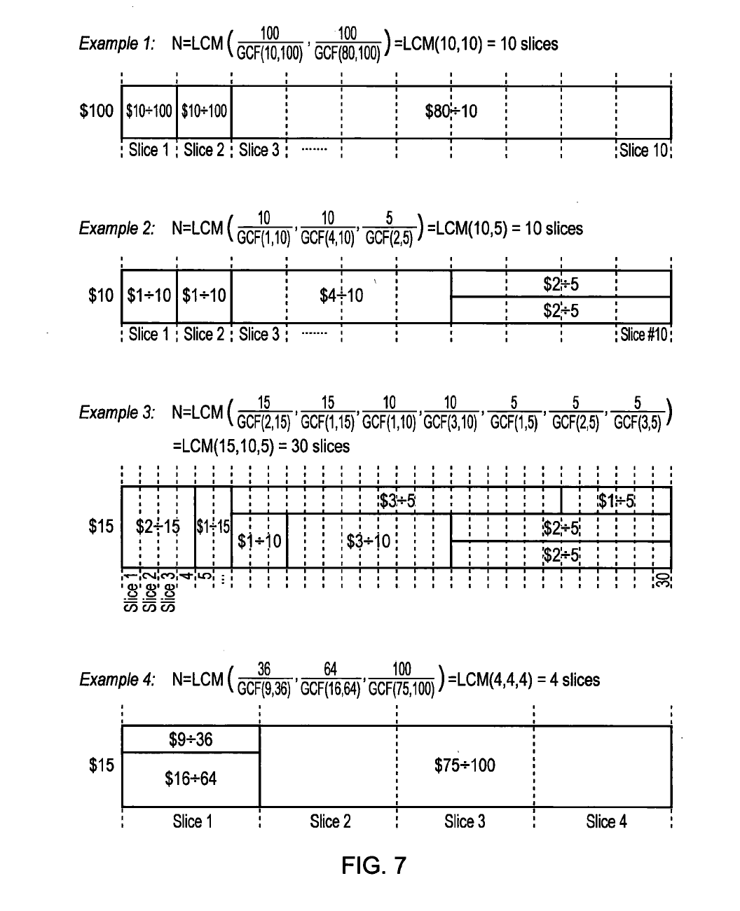

In the example above, the bets and compound bets are represented as rectangles. Other geometrical shapes can be used to represent the bets, for example the bets may be represented as annulus segments, combined into a compound set of bets represented as a complete annulus for example, as seen in FIG. 6.

### DRAW

Preferably, to ensure a fair draw, the step of performing a draw is only carried out when the compound second dimension of the compound betting block is equal to 1, the area of the compound betting block is equal to the winnings awarded to players or the annulus is complete if such a transformation has been used. This ensures that the block will contain sufficient capital to cover all constituent bets.

To carry out the draw, there are 4 steps
Split the block in equal vertical slices
Allocate a unique number for each vertical slice
Perform a fair draw to pick a single number/slice
Allocate the total prize amount, which is equal to first dimension, to the owners of the winning slices

### Splitting the Block in Slices

The compound betting block is preferably divided into equal regions in the form of slices. The slices extend completely across the compound betting block in the direction of the first dimension, i.e. each slice has a first dimension equal to the first dimension of the compound betting block. The width of each slice (i.e. in the direction of the second dimension) is preferably selected so that the compound betting block and each individual betting block within the compound betting block contains an integer number of slices. It is then possible to conduct a fair draw by selecting at least one of the slices as a winning slice. The selected slice will intersect with one or more of the betting blocks contained within the compound betting block. The bets corresponding to these betting blocks (or in some cases single betting block) are the winning bets.

The block can include several bets. Assume these are $x₁÷y₁, $x₂÷y₂, $x₃÷y₃, etc.

The following process will illustrate how the betting block can be translated to a configuration that can host a fair random draw. For this purpose, each bet will be divided in small slices in such way that the number of slices would be proportional to its width.

All slices must have the same width. This is for two reasons:
We can apply a fair draw on the slices based on random symmetrical selection; and
The aforementioned fair draw can reflect fairly the probability of winning for each bet

Assume we divide the block in N slices, i.e. each slice has a width=1/N.

The only requirement is that, when slicing the compound block, all constituent blocks must be divided without a remainder. Then, since all blocks will be divided with a common unit, the number of slices that belong to each betting block will be proportional to its width. Hence, any constituent arbitrary bet $x÷y must be divided in

$$\frac{Nx}{y}$$

slices, since it has length=x/y. It is also necessary to guarantee this figure is an integer number for all bets in the block.

Hence, we need to find a suitable width (=1/N) for the slices such that for each bet $x÷y the number of slices

$$( = \frac{Nx}{y} )$$

is an integer. Having done this, we simply slice the whole block, and the constituent blocks will be sliced perfectly without leaving a remainder.

We explain further below how the above approach provides a fair draw.

The appropriate number of equal slices in which we split the matched block is

$$N = LCM ( \frac{{y}_{1}}{GCF ( {x}_{1} , {y}_{1} )} , \frac{{y}_{2}}{GCF ( {x}_{2} , {y}_{2} )} , \frac{{y}_{3}}{GCF ( {x}_{3} , {y}_{3} )} , … )$$

### LCM: Least Common Multiple

### GCF: Greatest Common Factor

This definition ensures
All constituent blocks in the compound block are sliced in equal parts, i.e. there is no remainder
N is the smallest number that satisfies the above rule

Any higher integer multiple of N will also work to create a fair draw. The number of slices in reduced to the minimum allowed size in order to avoid slicing redundancy.

In summary,

Assume an arbitrary bet $x÷y which is part of this matched block.
The block is split in N slices, which is determined by the formula above
Each slice has width=1/N
Each $x÷y bet, will be split in

$$\frac{Nx}{y}$$

integer slices (i.e. no remainder in the start or the end)
The slices will have equal width for each constituent block

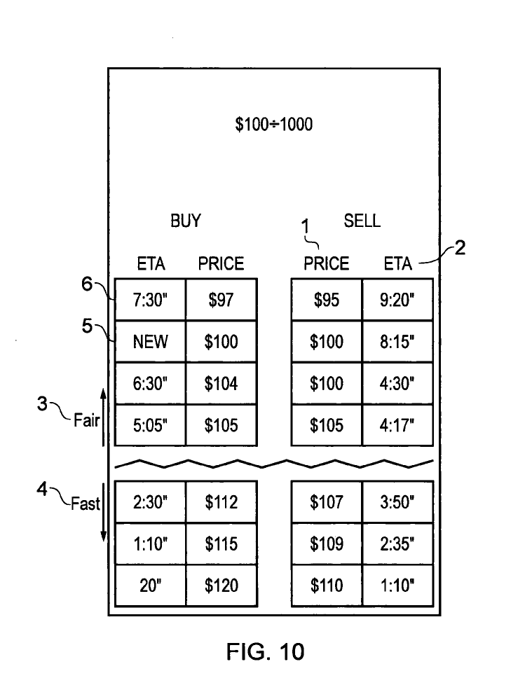

Examples of sliced blocks are shown in FIG. 8.

### Allocate a Unique Number for Each Slice

The step of selecting at least one of the slices as a winning slice may comprise allocating a unique number to each slice and using a random number generator to pick one or more of the unique numbers allocated to the slices. The random generation is symmetrical, and will give equal statistical opportunity to all slices. This process is equivalent to a standard fair roulette draw. Essentially, the probability for each slice to be drawn is 1/N.

### Perform a Fair Draw to Pick a Single Number/Slice

The slice having the selected unique number is the winning slice. Once the winning slice has been selected, and hence the winning bet or bets determined, the total pay-out amount can be allocated to the winning bet or bets. The prize amount for each winning bet will be the respective win value y of that bet.

However, instead of choosing the winning slices, we can also eliminate the slices gradually until only one is left. Each pool will have a series of elimination rounds. During each elimination round, executed at a predefined time with a countdown timer, a randomly selected subset of the slices will be eliminated. This gives players the opportunity to assess how they are doing and take one of the following actions:
Do nothing and wait for the next round
Sell a subset of or all the slices to another player
Buy additional slices from the other players.

The amount of time between elimination rounds will be set and players have to make sure that all the trades have been completed within the allocated time. All remaining active offers will be cancelled right before the next elimination round.

Additionally, as there are fewer slices in play after each elimination round, the value of the surviving slices will increase. When trading, it is up to the players to decide the price at which they will sell and buy. But, when choosing an appropriate price for their slices, players also need to consider what the others are thinking, as well as the time constraint before the next elimination round.

### Allocate the Total Prize Amount to the Owners of the Winning Slices

The random selection is performed and a single slice is drawn. Then, the ‘owners’ of this slice (i.e. the players who placed the bets represented by the bet blocks that intersect with the winning slice) will be awarded with a prize amount equal to the win amount ‘y’ of their bet.

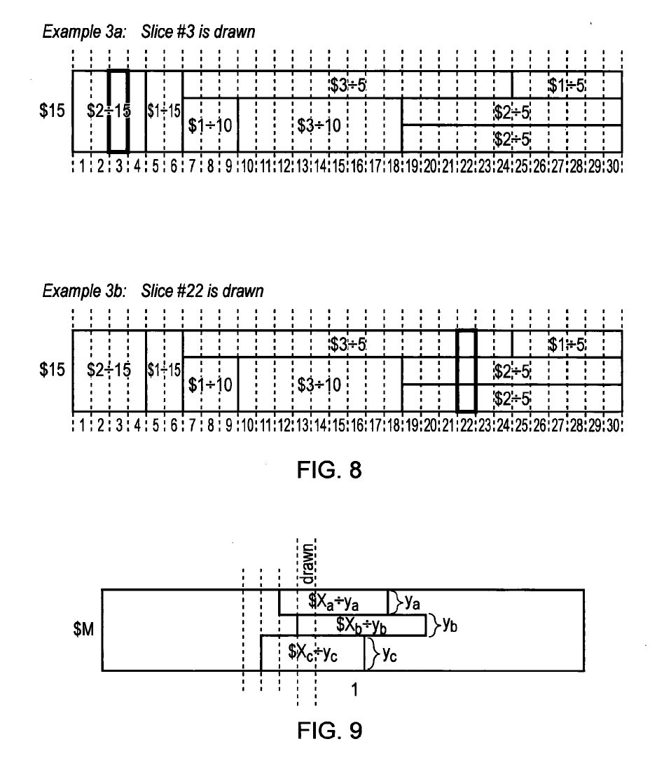

Example 3a in FIG. 8 shows an example based on example 3 in FIG. 7, in which slice #3 is drawn as the winning slice. In this simple case, the winning slice is part of a single bet $2÷15. Hence this player will be awarded the full amount in the pool which is $15. It can be noted that the ‘owner’ of $2÷15 had bet $2 to win $15; which is exactly the amount he was awarded as a prize for having a bet intersected by the winning slice. It can also be noted that $15 is the total amount that all of the players in the pool have collectively contributed.

Example 3b in FIG. 8 illustrates a more complex example in which several different bets are intersected by the winning slice, in this case slice #22. Specifically, there are three bets that intersect the slice:
$2÷5
$2÷5
$3÷5

Hence, 3 players will be awarded the prize that they bet for. Their winnings are equal to the win amount of their individual bets, which in this case is $5 for each of them. It can be noted again that the total amount won by the 3 players that have won is equal to $15, which is the total amount that all the players in the pool have collectively contributed.

### Proof

The following disclosure is included to prove the following:
All bets that participate in the draw maintain the promised probability of winning
All bets that participate in the draw maintain the promised odds (which is equivalent to maintaining the promised award amount)
The cash required to pay off the winners in any possible draw outcome is equal to the total cash collectively accumulated from bets in the draw.
Bets are split in integer number of slices

### Slices

Assume a “matched” block with
Horizontal dimension=1
Vertical dimension=$M

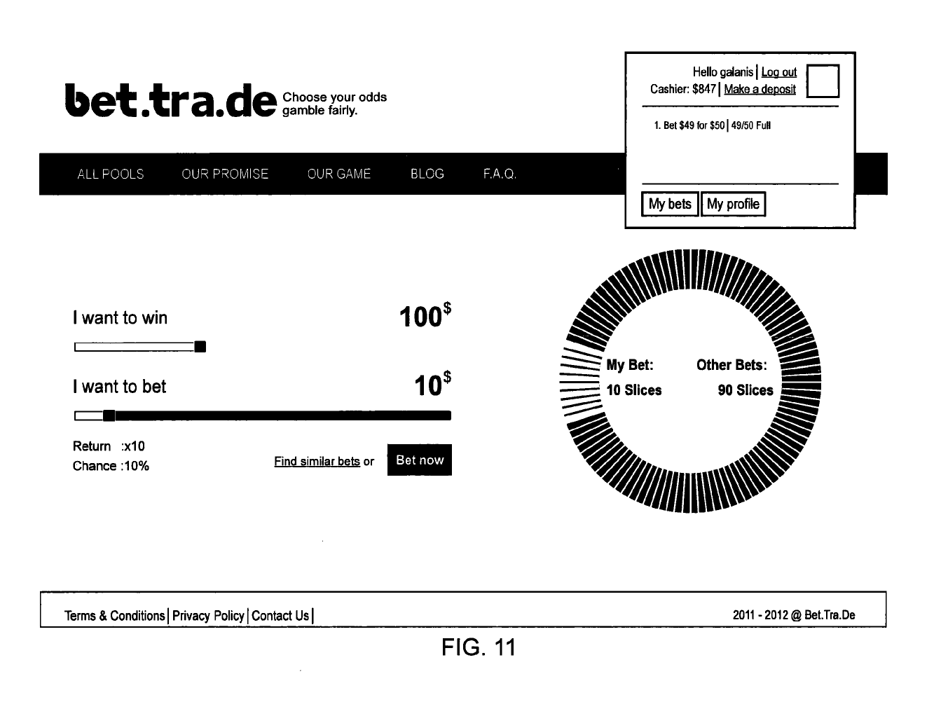

Also assume an arbitrary bet $x÷y, which is a constituent of the block (e.g. $xₐ÷yₐ in FIG. 9).

As described above, it is required that the bet is split proportionally to its length:

$$\frac{width of compound block}{slices of compound block} = \frac{width of \$ x \div y block}{slices of \$ x \div y block} ⇒ \\ \frac{1}{N} = \frac{x / y}{slices of \$ x \div y block} ⇒ \\ slices of \$ x \div y block = \frac{Nx}{y}$$

We split the compound block

$$N = LCM ( \frac{{y}_{1}}{GCF ( {x}_{1} , {y}_{1} )} , \frac{{y}_{2}}{GCF ( {x}_{2} , {y}_{2} )} , \frac{{y}_{3}}{GCF ( {x}_{3} , {y}_{3} )} , … )$$

slices.

The requirement is that the slices of each block

$$( = \frac{Nx}{y} )$$

is an integer.

$$\begin{matrix}GCF ( {x}_{i} , {y}_{i} ) is a factor of {y}_{i} ⇒ \frac{{y}_{i}}{GCF ( {x}_{i} , {y}_{i} )} is an integer \\ N is a multiplier of all \frac{{y}_{i}}{GCF ( {x}_{i} , {y}_{i} )}\end{matrix} \} ⇒ \begin{matrix}N = {k}_{i} \frac{{y}_{i}}{GCF ( {x}_{i} , {y}_{i} )} \\ where {k}_{i} is an integer multiplier\end{matrix}$$

The arbitrary bet $x÷y will be split in

$$\frac{Nx}{y}$$

slices:

$$\frac{Nx}{y} = k \frac{y}{GCF ( x , y )} \frac{x}{y} = k \frac{x}{GCF ( x , y )}$$

Since GCF(x,y) is a factor of x, the number of slices is always an integer.

According to the betting definition, $x÷y describes a bet

where the players bets $x
with decimal odds=y/x
and probability of winning=x/y

We will now prove that all the above requirements can be fulfilled.

### Probability

The draw maintains equal/fair probability for all slices. Therefore,

$$\{ Probability of winning \} = \{ Probability of the bet ' s slices to be drawn \} = \frac{slices of the bet}{total slices} = \frac{\frac{Nx}{y}}{N} = \frac{x}{y}$$

### Available Cash

We will prove that the total cash collected from all the bets in the block is equal to $M.

As described above, the dimensions of the block belonging to $x÷y are as shown in FIG. 2.

By definition, the “matched block” is a perfect composition of the individual betting blocks. Therefore,

$$\{ The areas of all constituent blocks \} = \{ The area of the complete block \} ⇒ ( {y}_{1} \cdot \frac{{x}_{1}}{{y}_{1}} + {y}_{2} \cdot \frac{{x}_{2}}{{y}_{2}} + {y}_{3} \cdot \frac{{x}_{3}}{{y}_{3}} + … ) = \$ M \cdot 1 ⇒ {x}_{1} + {x}_{2} + {x}_{3} + ... = \$ M$$

But x₁, x₂, x₃, are the cash values the players have placed for all bets in the block.

Therefore, the total collected cash is equal to $M.

### Odds & Required Cash

Assume an arbitrary slice is drawn. This slice will belong to 1 or more betting blocks as in the example in FIG. 9.

Each winner will request payouts according to his bet.

For the winning bets $xₐ÷yₐ, $x_{b}÷y_{b}, $x_{c}÷y_{c},

the required payouts are yₐ, y_{b}, y_{c}

Note1: The winning slice may belong to any amount of bets, not limited to 3 as in the example

Note2: The winning bets are a (small) subset of all the bets in the block

Note3: Because all betting blocks fit integer number of slices, the winning slice will be perfectly aligned with the borders of each betting block

The compound “matched” block is perfectly composed by the constituent blocks. Therefore, at any horizontal point in the block, the vertical dimensions of the constituent blocks must be equal to the vertical dimension of the compound block.

Any slice has height equal to the height of the block. But, the height of the winning slice is equal to the sum of heights of the constituent blocks. This can be visually observed in the example:

$M=yₐ+y_{b}+y_{c}

Therefore, the available cash (=$M), is exactly sufficient to cover the required payouts of all winning bets, meaning that the players winners/players of the bets $xₐ÷yₐ, $x_{b}÷y_{b}, $x_{c}÷y_{c},
placed xₐ, x_{b}, x_{c}, and
will be awarded yₐ, y_{b}, y_{c}

Therefore, their odds in decimal notation are on the bets are
yₐ/xₐ
y_{b}/x_{b}
y_{c}/x_{c}

To conclude, when a player bets $x÷y, the system always ensures the following:
he places $x (by requirement)
he has probability of winning=x/y
he is offered payback with decimal odds=y/x

### Bet Exchange

Embodiments of the present invention provide a computer Betting Exchange for games of chance. The unique characteristic of the aforementioned betting exchange concentrates on exchanging bets with known/guaranteed odds and known probability of winning.

The computer or computer system and the Betting Exchange will operate in parallel facilitating the purpose of one another. The computer system will accept requests for new bets (via the Bet Placement system), and work for the purpose of finding matched betting groups to create new draws; hence it will accept a limitless variation of bets, but with no guaranteed time of delivery. The Betting exchange will provide a smaller portion of available bets but with guaranteed time of delivery. This difference in features suggests that the same bet might be available at different costs between the computer system and the Betting Exchange, subject to supply and demand.

The Betting Exchange collects all bets that are either sold from the players or can't be matched from the computer or computer system to facilitate and accelerate the execution of betting demand by the players/users. The Primary Market of the Betting Exchange includes
1) new unmatched bet requests, which the computer or computer system forwards to the Betting Exchange;
2) new unmatched bids for bets available at an arbitrary price set by the players/users directly at the Betting Exchange.

These Primary Market quotes are fed back to the computer or computer system via the electronic network (FIG. 1) when a matched group can be formed: in this way the Betting Exchange enhances the bet liquidity. The computer or computer system communicates via an electronic network both with the Betting Exchange Primary Market and the Bet Collection in continuous search of matched bet groups (FIG. 1).

The Secondary Market activity of the Betting Exchange includes
1) ask quotes for bets in a mid-round draw
2) instant sales of mid-round bets to Primary Market bids for an identical bet

In preferred embodiments, quotes from the Primary and Secondary Market will be simultaneously available to provide the fair market value of each bet based on supply and demand and enhance the gaming experience of the user/player.

In preferred embodiments, the Players/Users will interact directly with the Bet Collection and the Exchange through an electronic terminal connected to the network. The player/user in respect of placing a bet may
1) Place a request for a new bet at fair price, which will be controlled by the bet placement system and computer system core
2) Place a bid for a new bet at a price of his choice. This bet may join a new draw allocated by the computer system, or accepted by a buyer in the Secondary Market
3) Buy a bet from the Betting Exchange Primary Market with fixed waiting time to join a Draw. This bet may be available through a plurality of new bets and/or new bids for bets.
4) Buy a bet from the Betting Exchange Secondary Market to instantly join a mid-round draw. This may be a single bet, or a composite bet consisting of several secondary market bets belonging to the same draw

The player/user in respect of a selling a live bet in mid-round draw may
1) Place an ask quote for the bet in the Secondary Market
2) Sell instantly to the current bid price in the Betting Exchange. This quote will be available from the Primary market either from a single bidder of an identical bet, or a composition of several bets from a plurality of bidders.

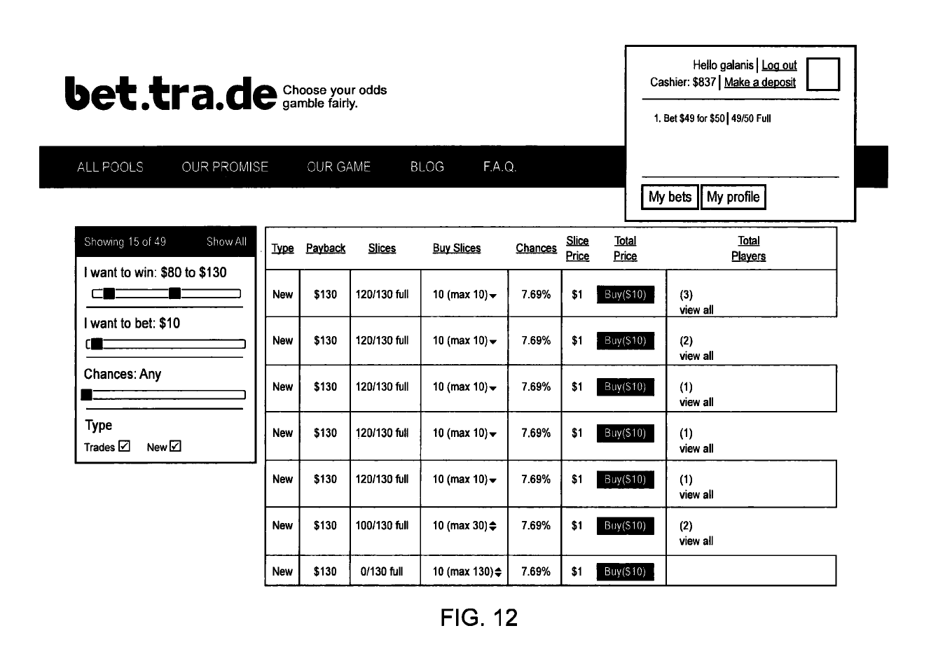

A preferred illustration of the buy and sell quotes of a single bet, in this case $100÷1000, is displayed in the Betting Exchange is shown in FIG. 10. All quotes carry both price and remaining time (FIG. 10, elements 1 & 2). The buy and sell quotes refer to the prices at which the player/user can buy or sell, respectively.

Buy quotes for any bet originate from the following scenarios
1) directly from the computer system, which accepts all possible bet requests at fair value, i.e. price is equal to expected value, in this case $100 (FIG. 10, element 5). These bets do not guarantee remaining time to draw, although in preferred embodiments an estimate may be displayed.
2) via composition of its complementary bet from other bet requests in the primary market. These bets will guarantee remaining time to draw, which is equal to the time necessary to complete all rounds from start to finish.
3) via the secondary market from other players selling in mid-round. These bets also have guaranteed remaining time, which is equal to the time necessary to finish the remaining draws, which CaO possibly be very small.

Buy quotes that originate from the secondary market have a variable price subject to supply and demand. Occasionally, bets will be traded at prices lower than their expected value (FIG. 10, element 6), which present with a statistical opportunity.

Sell quotes originate from primary market bid requests, i.e. players bidding to make a specific bet, e.g. a player bids $110 for a $100÷1000 bet, with remaining time to draw being 2 minutes or less. In this case the player overbids for a faster draw, i.e. bids at a price higher than the fair value of the bet. These bids (with small remaining time) can only be executed from owners of secondary market mid-round bets.

Note that selling a mid-round bet is not equivalent to short-selling or laying a bet, that being betting on complementary odds. Should players want to short-sell or lay a bet, they will need to do so by betting on the complementary odds, in this case $900÷1000, which will generally include independent buy and sell quotes from the original bet.

The players will have to consider the betting elements that are important to their trading strategy and make relevant trade-offs. For example, a common trade will be that between cost and remaining time. It is expected that small remaining time will reflect price at a premium, i.e. higher than the expected value, and long remaining time will reflect price at a discount, i.e. lower than the expected value, but actual quotes will eventually only be based on supply and demand.

The computer exchange will allow users to sort against the betting elements of their preference to allow effective pricing. In the trade-off example of cost versus remaining time, the system will preferably display cheapest bets and fastest bets separately (FIG. 10, elements 3 & 4). A number of the cheapest quotes, along with a number of the faster-to-draw quotes, will be independently displayed.

### Example Embodiment of a Game

An example embodiment of a game of chance will now be described, with reference to FIGS. 12-14. In the example embodiment the following terms will also be adopted:
Bet—the funds that the player bets (e.g. $5—commonly annotated as “X”).
Payback—the funds that the player wishes to win (e.g. $100—commonly annotated as “Y”).
Betting—the action of buying slices of a pool from the system (e.g. at a price of $1).
Buying—the action of buying slices in a pool from other players, at the market price as defined by the player.
Selling—the action of selling slices of a pool to another player, at the market price as defined by the player.
Probability—probability that a player will win Y, defined as the ratio of slices owned in a given pool (e.g. in a pool that has 10 slices, a user owning 2 slices has 20% chances of winning Y).
Decimal odds—the inverse of probability as there is no house/commission.
Free-money—the game played with free money distributed by the game.
Deposit rate—the rate at which free-money is distributed from the game.
Cash game—the game played with real money.
Player levels—levels awarded to active players, unlocking additional functionality.

This example embodiment is played in a single pool and the players' goal is simple: win the desired amount either completely by chance or through strategic trading within the players' round. Additionally, players will be able to earn entry into exclusive playing circles with other top strategists, and be awarded titles with experience.

The payback of a given pool is awarded to the owner of the last slice as all the others are eliminated randomly. Since players can trade bets with others during gameplay, ii comes down to how much that win is worth to each individual.

The structure of the game can be broken up into three main divisions:
1. Creating the pools
2. Elimination rounds
3. Announcing the winner

### Creating the Pools

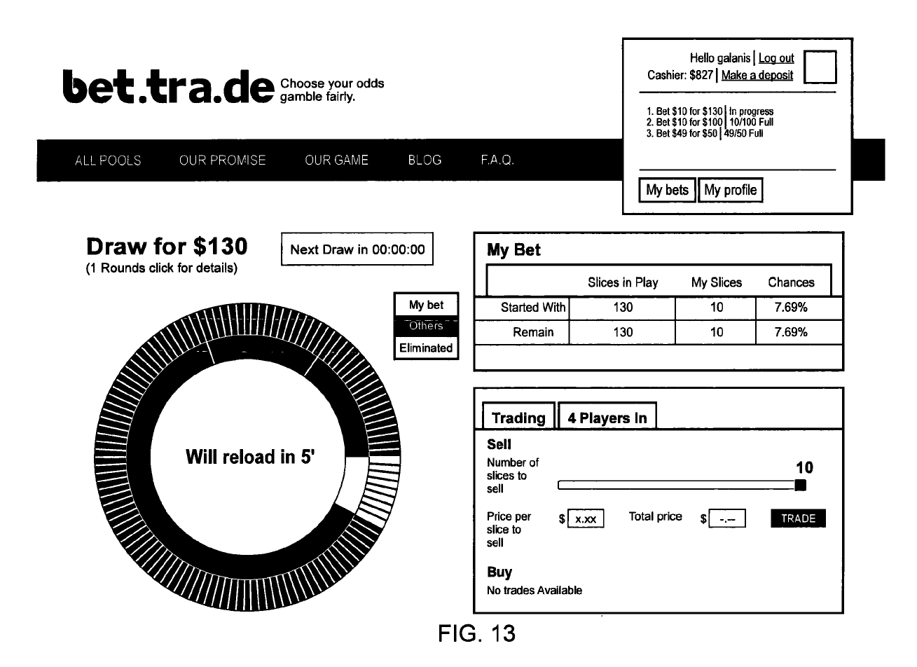

When players place a bet (e.g. via the user interface shown in FIG. 11), the game sells to them the appropriate number of slices within a given pool for $1 each. For example, when a $5÷$100 bet is placed, the player will be given 5 slices in the pool awarding $100, which will have a total of 100 slices that are each worth $1 and have exactly 1% probability of winning. The remaining slices will be bought from others and the player will have 5% probability of winning $100.

Players can start a new game and choose how much money they want to have a chance of winning, and how much they want to win by means of sliding scales, as shown in FIG. 11. This sets up a new pool. The slices that they have purchased will be indicated on the compound betting block, which in this example is an annulus.

Alternatively, players can join a game that has already been started, by buying betting blocks within a pool, as shown in FIG. 12.

Once all the slices of a pool have been purchased, gameplay will begin.

### Elimination Rounds

Each pool will have a series of elimination rounds. During each elimination round, a randomly selected subset of the slices will be eliminated. This gives players the opportunity to assess how they are doing and take one of the following actions:
1. Do nothing and wait for the next round
2. Sell a subset of or all the slices to another player
3. Buy additional slices from the other players.

An example user interface that allows the processes 1-3 described above is shown in FIG. 13.

The amount of time between elimination rounds will be set and players have to make sure that all the trades have been completed within the allocated time. All trades will be cancelled right before the next elimination round.

Additionally, as there are fewer slices in play after each elimination round, the value of the surviving slices will increase. When trading, it is up to the players to decide the price at which they will sell and buy. But, when choosing an appropriate price for their slices, players also need to consider what the others are thinking, as well as the time constraint before the next elimination round.

### Announcing the Winner

The elimination rounds will continue until a single slice remains within a given pool. The owner of that slice will be awarded the payback of that pool.

### Variations

The above game rules will have a few variations depending on the player's level and chosen interface. Namely:
Free-money vs cash game—this allows users to choose the platform they prefer.

(In the free-money game, $0.001 of virtual currency may be added every second ($86.4/day). The players will have the opportunity to increase their deposit rate, depending on periodic offers, but can also risk decreasing it if they are not active. Cash game funds will be deposited to their online account.)
Betting—the number of bets or trades players place may be limited by the system so as to give everyone the opportunity to play.
Time—the time between the elimination rounds will change depending on the pool the players choose.
Merging—to accelerate the “creating the pools” process, pools may be merged to generate the requested bets. Players can opt in or out of this feature.
Friends/VIPs—there will be a few pools that players can only join by invitation.
Elimination rounds—the number of elimination rounds will vary among all the pools.
Trading—players might be restricted to trading within the same pool, or across the pools they are participating in, before they are allowed to trade across the site.

The skilled person will appreciate that various modifications to the specifically described embodiments are possible without departing from the invention.

1. A computer or computer system for operating a game of chance, the computer or computer system comprising:
a. at least one processor;
b. means for receiving a plurality of bets from players; and
c. memory for storing the received bets,
wherein the computer or computer system is operable under the control of at least one processor to offer bets of chance of any explicit odds, and guarantee the probability of winning, and to conduct a draw to determine one of more winning bets from said plurality of received bets stored in memory in accordance with said guaranteed probability of winning.

2. A computer or computer system according to claim 1, operable to create betting liquidity by creating complementary bets without the presence of lay bets.

3. A computer or computer system according to claim 1, wherein bets received from players are defined by the computer or computer system as two data points; the amount a player wants to bet, and the amount the player wants to win.

4. A computer or computer system according to claim 1, operable to treat each received bet as potential capital to cover for a bet of complementary odds.

5. A computer or computer system according to claim 2, operable to create groups of bets whereby for every bet in the group, the remaining bets complete cumulatively a statistically equivalent complementary bet.

6-11. (canceled)

12. A computer implemented method for conducting a game of chance, the method comprising:
a. receiving a plurality of bets;
b. combining the bets; and
c. performing a draw within the combined bets to determine one or more winning bets,
wherein the step of combining the plurality of bets comprises defining each bet as a shape having at least two dimensions and combining the shapes to form a two-dimensional bet space, wherein the bet space is made up of a mosaic of the shapes.

13. A method according to claim 12, wherein the step of performing the draw comprises selecting one or more regions within the bet space, any bet represented by a shape that is at least partly within the selected region being determined to be a winning bet.

14. A method according to claim 12, wherein the area of the bet space represents the total prize pool that can be won; and, optionally, the area of each shape that defines a bet represents the probability of that bet winning a prize from the pool

15. (canceled)

16. A computer implemented method of combining a plurality of bets, each presented by two data-points of “x” and “y”, which are “bet value x to attempt to win value y”, the method comprising:
a. converting each bet into a betting block defined by two dimensions, a first dimension proportional to data point y, and a second dimension representing a ratio of the data point x over data point y; and
b. combining two or more betting blocks to form a compound betting block containing said two or more betting blocks, wherein the compound betting block is defined in the same way.

17. A method according to claim 16, wherein a compound block is formed with the method of perfect tiling, i.e. creating a perfect rectangle without gaps, then its dimensions would define its bet equivalent, i.e. its first dimension representing the new data point y, and its second dimension representing new data point x over new data point y.

18. A method according to claim 16, wherein each betting block is further defined by a third dimension, the third dimension representing the price at which a player can buy the betting block.

19. A method according to any one of claim 16, wherein the two dimensions defining each betting block can be represented as a two dimensional shape,

20-24. (canceled)

25. A computer implemented method for conducting a game of chance, the method comprising:
a. receiving a plurality of bets, each bet being a bet of value x to attempt to win a value y;
b. combining the bets using a method according to claim 16; and
c. performing a draw to determine one or more winning bets.

26. A method according to claim 25, wherein the step of performing a draw is only carried out when the second dimension of the compound betting block is equal to 1.

27. A method according to claim 25, wherein the step of performing the draw comprises:
a. dividing the compound betting block into equal slices, wherein each slice has a first dimension equal to the first dimension of the compound betting block and the width of each slice is selected so that the compound betting block and each individual betting block within the compound betting block contains an integer number of slices; and
b. selecting at least one of the slices as the winning slice,
wherein any bet represented by a betting block within the compound betting block that intersects with the winning slice is determined to be a winning bet.

28. A method according to claim 27, wherein the step of selecting at least one of the slices as a winning slice comprises allocating a unique number to each slice and using a random number generator to pick one or more of the unique numbers allocated to the slices.

29. A method according to claim 28, wherein the step of selecting at least one of the slices as a winning slice comprises eliminating a plurality of slices from the draw, the or each remaining slice or slices being a winning slice.

30. A method according to claim 29, wherein said plurality of slices are eliminated in a series of elimination rounds, during each elimination round, executed at a predefined time with a countdown timer, a randomly selected slice or subset of the slices being eliminated and, optionally, between each elimination round players are given the opportunity to sell one or more betting blocks to another player and/or to buy one or more additional betting blocks from other players.

31-32. (canceled)

33. A computer Betting Exchange operable in conjunction with a game of chance played on a computer or computer system according to claim 1 wherein the odds and probability of winning are known for each bet, the Betting Exchange operable to enable a player to purchase a bet for a given price.

34-37. (canceled)

38. A computer Betting Exchange according to claim 33, wherein the players interact with the Betting Exchange through an electronic terminal connected to the network, or Internet, by:
a. placing requests for a new bet at fair price, which will be controlled by the computer or computer server;
b. placing a bid for a new bet at a price of his choice;
c. buying a bet from the Betting Exchange with guarantee to instantly join a draw that hasn't started selecting the winner; and
d. buying a bet from the Betting Exchange with guarantee to instantly join a mid-round draw.

39-41. (canceled)
